(19) United States
(12) Patent Application Publication
(10) Pub. No.: US 2026/0328094 A1
(43) Pub. Date: Oct. 22, 2026

(54) STEAM TURBINE AND METHOD FOR MODIFYING SAME

(71) Applicant: MITSUBISHI HEAVY INDUSTRIES, LTD., Tokyo (JP)

(72) Inventors: Tsutomu Ogino, Tokyo (JP); Hideo Yamamoto, Tokyo (JP); Seemindaryl Soh, Tokyo (JP); Yasuyuki Tatsumi, Tokyo (JP)

(73) Assignee: MITSUBISHI HEAVY INDUSTRIES, LTD., Tokyo (JP)

(21) Appl. No.: 19/113,994

(22) PCT Filed: Sep. 7, 2023
(86) PCT No.: PCT/JP2023/032752

§ 371 Date: Mar. 21, 2025

(30) Foreign Application Priority Data
Oct. 6, 2022 (JP) 2022-161529

(51) Int. Cl. F01D 5/00; F01D 25/24; F01D 25/30; F02C 7/143

(52) U.S. Cl. CPC F01D 5/005; F01D 25/24; F01D 25/30; F02C 7/1435; F05D 2220/31; F05D 2230/80

(57) ABSTRACT

In this method for modifying a steam turbine, a blade removal step and a flow path partition step are implemented. In the blade removal step, a plurality of rotor blade rows including a rotor blade row on the most axially downstream side and adjacent to each other in the axial direction among a plurality rotor blade rows are removed, and stator vane rows adjacent to the plurality of removed rotor blade rows on the axially upstream side of the respective rotor blade rows among the plurality of stator vane rows are removed. In the flow path partition step, an annular steam flow path formed between the inner peripheral side of a rotor casing and the outer peripheral side of a rotor shaft is partitioned at a position on the axially downstream side of a final-stage rotor blade row, which is the rotor blade row on the most axially downstream side among one or more rotor blade rows left after the blade removal step.

### TECHNICAL FIELD

The present invention relates to a steam turbine and a method for modifying the same.

This application claims priority based on JP 2022-161529 filed in Japan on Oct. 6, 2022, the contents of which are incorporated herein by reference.

### BACKGROUND ART

Many steam turbine facilities include a boiler, a steam turbine driven by steam from the boiler, a generator driven by the steam turbine to generate power, and a condenser that condenses steam discharged from the steam turbine into water.

For example, Patent Document 1 discloses a method for modifying a steam turbine facility for effectively using heat of steam generated in a boiler. The steam turbine facility before modification in Patent Document 1 includes a high-pressure steam turbine driven by steam from a boiler, a low-pressure steam turbine driven by steam discharged from the high-pressure steam turbine, a generator driven by the high-pressure steam turbine and the low-pressure steam turbine to generate power, and a condenser that condenses steam discharged from the low-pressure steam turbine into water. In the technique described in Patent Document 1, the steam turbine facility is modified such that steam discharged from the high-pressure steam turbine is not led to the low-pressure steam turbine but led to another steam utilization facility as process steam. In this technique, there is no heat loss occurring in the process of condensing the steam into water in the condenser, and therefore the heat of the steam from the boiler can be effectively used, although the amount of power generated by the generator is reduced since the steam is not led to the low-pressure steam turbine.

### CITATION LIST

### Patent Literature

Patent Document 1: JP 2006-002696 A

### SUMMARY OF INVENTION

### Technical Problem

In the technique described in Patent Document 1, the pressure and temperature of the steam to be fed to the steam utilization facility are limited, although the heat of the steam from the boiler can be effectively used.

Therefore, in the technique described in Patent Document 1, steam having the pressure and the temperature requested by the steam utilization facility may not be supplied.

Thus, an object of the present disclosure is to provide a steam turbine modification method that allows feeding steam having a pressure and a temperature corresponding to a request from a steam utilization side to a steam utilization facility, and a steam turbine obtained by executing the modification method.

### Solution to Problem

A method for modifying a steam turbine according to one aspect of the invention for achieving the above object is directed to the following steam turbine.

The steam turbine includes: a rotor rotatable about an axis; a rotor casing covering an outer peripheral side of the rotor; and a plurality of stator vane rows provided on an inner peripheral side of the rotor casing and arranged in an axial direction in which the axis extends. The rotor includes a rotor shaft extending in the axial direction about the axis, and a plurality of rotor blade rows provided on the rotor shaft. Each of the plurality of rotor blade rows is disposed on an axially downstream side, in the axial direction, of any one of the plurality of stator vane rows.

The method for modifying a steam turbine includes: a blade removal step of removing a plurality of rotor blade rows including a rotor blade row on a most axially downstream side and adjacent to each other in the axial direction, or the rotor blade row on the most axially downstream side, among the plurality of rotor blade rows, and removing a stator vane row adjacent to each of the one or more rotor blade rows to be removed on an axially upstream side, in the axial direction, of the one or more rotor blade rows, among the plurality of stator vane rows, so that at least a rotor blade row on a most axially upstream side, among the plurality of rotor blade rows, remains and at least a stator vane row on the most axially upstream side, among the plurality of stator vane rows, remains; and a flow path partitioning step of partitioning an annular steam flow path formed between the inner peripheral side of the rotor casing and an outer peripheral side of the rotor shaft at a position on the axially downstream side of a final-stage rotor blade row being a rotor blade row on the most axially downstream side, among the one or more rotor blade rows remaining after the blade removal step.

In the present aspect, the steam from the steam turbine is not fed to the condenser, and the steam in the upstream space on the final-stage rotor blade row side of the position where the steam flow path is partitioned can be fed to the steam utilization facility. Therefore, in the present aspect, there is no heat loss occurring in the process of condensing the steam into water in the condenser, and the heat of the steam from the boiler can be effectively used.

In addition, in the present aspect, it is possible to feed the steam having the pressure and the temperature corresponding to the request from the steam utilization side to the steam utilization facility by appropriately selecting the cascade stage to be removed.

A steam turbine according to one aspect of the invention for achieving the above object includes: a rotor rotatable about an axis; a rotor casing covering an outer peripheral side of the rotor; one or more stator vane rows provided on an inner peripheral side of the rotor casing and arranged in an axial direction in which the axis extends; a partition plate that partitions a steam flow path; and an exhaust flow path forming portion in which an exhaust flow path capable of leading steam to outside of the rotor casing is formed. The rotor includes a rotor shaft extending in the axial direction about the axis, and one or more rotor blade rows provided on the rotor shaft. Each of the one or more rotor blade rows is disposed on an axially downstream side, in the axial direction, of any one of the one or more stator vane rows. The steam flow path is an annular flow path formed between the inner peripheral side of the rotor casing and an outer peripheral side of the rotor shaft. The partition plate partitions the steam flow path at a position on the axially downstream side of a final-stage rotor blade row which is a rotor blade row on a most axially downstream side, among the one or more rotor blade rows. The exhaust flow path is capable of leading steam in a space on a side of the final-stage rotor blade row with respect to a position where the steam flow path is partitioned in the steam flow path to outside of the rotor casing.

### Advantageous Effects of Invention

According to one aspect of the present disclosure, it is possible to feed steam having a pressure and a temperature corresponding to a request from a steam utilization side to a steam utilization facility.

### BRIEF DESCRIPTION OF DRAWINGS

FIG. 1 is a schematic cross-sectional view of a steam turbine before modification according to a first embodiment of the present disclosure.

FIG. 2 is a flowchart illustrating a procedure of a steam turbine modification method according to the first embodiment and a second embodiment of the present disclosure.

FIG. 3 is a schematic cross-sectional view of the steam turbine after modification according to the first embodiment of the present disclosure.

FIG. 4 is a schematic cross-sectional view of a main portion of the steam turbine after modification according to the first embodiment of the present disclosure.

FIG. 5 is a schematic cross-sectional view of the steam turbine after modification according to the second embodiment of the present disclosure.

FIG. 6 is a schematic cross-sectional view of a main portion of the steam turbine after modification according to the second embodiment of the present disclosure.

FIG. 7 is a schematic cross-sectional view of a steam turbine after modification according to a third embodiment of the present disclosure.

FIG. 8 is a schematic cross-sectional view of a main portion of the steam turbine after modification according to the third embodiment of the present disclosure.

FIG. 9 is a schematic cross-sectional view of a steam turbine after modification in a modification example of the first embodiment according to the present disclosure.

FIG. 10 is a schematic cross-sectional view of a steam turbine after modification in a modification example of the third embodiment according to the present disclosure.

### DESCRIPTION OF EMBODIMENTS

Hereinafter, embodiments and modification examples of a steam turbine modification method according to the present disclosure and a steam turbine obtained by executing the modification method will be described in detail with reference to the drawings.

### First Embodiment

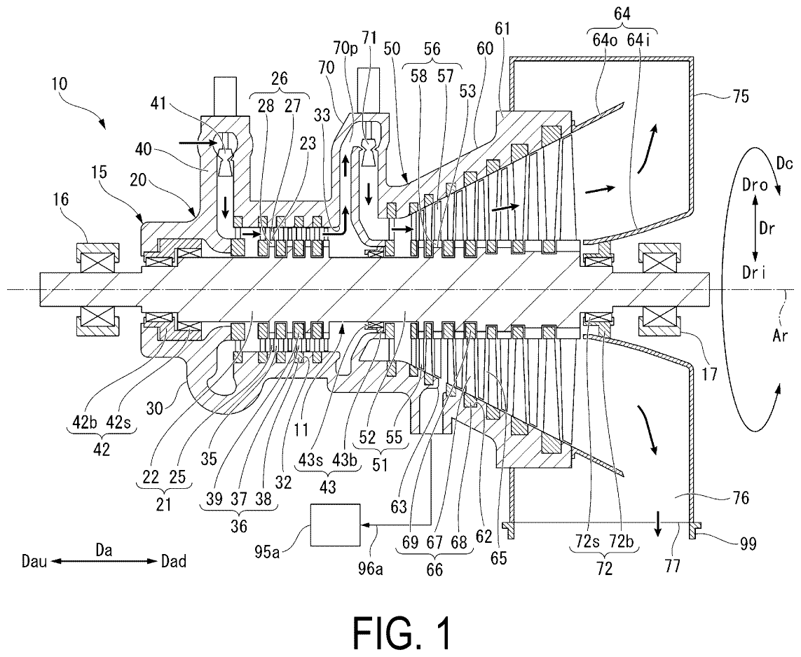

A steam turbine modification method according to a first embodiment and a steam turbine obtained by executing the modification method will be described with reference to FIGS. 1 to 4.

First, a steam turbine before modification will be described with reference to FIG. 1. A steam turbine 10 before modification includes a high-pressure steam turbine unit 20 and a low-pressure steam turbine unit 50.

The high-pressure steam turbine unit 20 includes a high-pressure rotor 21 rotatable about an axis Ar, a high-pressure rotor casing 30 covering an outer periphery of the high-pressure rotor 21, a plurality of stator vane rows 36, a high-pressure steam pipe 40, a high-pressure steam valve 41, a high-pressure shaft sealing device 42, and an intermediate shaft sealing device 43.

Here, the direction in which the axis Ar extends is referred to as an axial direction Da, one side in the axial direction Da is referred to as an axially upstream side Dau, and the other side in the axial direction Da is referred to as an axially downstream side Dad. In addition, the direction perpendicular to the axis Ar is referred to as a radial direction Dr, the side closer to the axis Ar in the radial direction Dr is referred to as a radially inner side Dri, and the side farther from the axis Ar in the radial direction Dr is referred to as a radially outer side Dro. Further, a circumferential direction relative to the axis Ar is simply referred to as a circumferential direction Dc.

The high-pressure rotor 21 includes a high-pressure rotor shaft 22 extending in the axial direction Da about the axis Ar, and a plurality of rotor blade rows 25 provided on the high-pressure rotor shaft 22. The high-pressure steam turbine unit 20 according to the present embodiment has four rotor blade rows 25. The plurality of rotor blade rows 25 are arranged in the axial direction Da at intervals from each other. Each of the plurality of rotor blade rows 25 includes a plurality of rotor blades 26 arranged in the circumferential direction Dc. The rotor blade 26 has a blade body 27 having a blade-shaped cross section and extending in the radial direction Dr perpendicular to the cross section, and a blade root 28 provided on the radially inner side Dri of the blade body 27.

The high-pressure rotor shaft 22 is formed with a rotor blade row mounting portion 23 to which blade roots 28 of the plurality of rotor blades 26 constituting the rotor blade row 25 are mounted. The rotor blade row mounting portion 23 is an annular groove recessed from the outer periphery of the high-pressure rotor shaft 22 toward the radially inner side Dri.

Each of the plurality of stator vane rows 36 is disposed on the axially upstream side Dau of any one of the plurality of rotor blade rows 25.

Accordingly, the high-pressure steam turbine unit 20 according to the present embodiment has four stator vane rows 36. That is, the high-pressure steam turbine unit 20 according to the present embodiment has four cascade stages.

One cascade stage is constituted by one stator vane row 36 and one rotor blade row 25. Each of the plurality of stator vane rows 36 includes a plurality of vane bodies 37 arranged in the circumferential direction Dc, and an outer ring 38 and an inner ring 39 which are annular about the axis Ar. The vane body 37 has a blade-shaped cross section and extends in the radial direction Dr perpendicular to the cross section. The outer ring 38 connects the ends, on the radially outer side Dro, of the plurality of vane bodies 37 arranged in the circumferential direction De to each other. The inner ring 39 connects the ends, on the radially inner side Dri, of the plurality of vane bodies 37 arranged in the circumferential direction De to each other. The high-pressure rotor casing 30 is formed with a stator vane row mounting portion 32 to which each of the plurality of stator vane rows 36 is mounted. The stator vane row mounting portion 32 is an annular groove recessed from the inside surface of the high-pressure rotor casing 30 toward the radially outer side Dro.

In the high-pressure rotor casing 30, the high-pressure steam pipe 40 is connected to a position on the axially upstream side Dau of the stator vane row 36 on the most axially upstream side Dau, among the plurality of stator vane rows 36. The high-pressure steam pipe 40 is provided with the high-pressure steam valve 41. In the high-pressure rotor casing 30, a high-pressure steam exhaust port 33 is formed on the axially downstream side Dad of the rotor blade row 25 on the most axially downstream side Dad, among the plurality of rotor blade rows 25. An annular space between the inner peripheral side of the high-pressure rotor casing 30 and the outer peripheral side of the high-pressure rotor shaft 22 on the axially downstream side Dad of the high-pressure steam pipe 40 and on the axially upstream side Dau of the high-pressure steam exhaust port 33 forms an annular high-pressure steam flow path 35 through which the high-pressure steam from the high-pressure steam pipe 40 flows.

In the high-pressure rotor casing 30, the high-pressure shaft sealing device 42 is disposed on the axially upstream side Dau of the high-pressure steam pipe 40. The high-pressure shaft sealing device 42 is a device that suppresses the high-pressure steam in the high-pressure rotor casing 30 flowing out from between the high-pressure rotor casing 30 and the high-pressure rotor shaft 22. The high-pressure shaft sealing device 42 includes a seal 42s facing the outside surface of the high-pressure rotor shaft 22 and a seal support base 42b supporting the seal 42s. The seal 42s and the seal support base 42b are both annular about the axis Ar. The seal support base 42b is connected to the inside surface of the high-pressure rotor casing 30.

In the high-pressure rotor casing 30, the intermediate shaft sealing device 43 is disposed on the axially downstream side Dad of the high-pressure steam exhaust port 33. The intermediate shaft sealing device 43 is a device that suppresses the high-pressure steam in the high-pressure rotor casing 30 flowing out from between the high-pressure rotor casing 30 and the high-pressure rotor shaft 22. The intermediate shaft sealing device 43 includes a seal 43s facing the outside surface of the high-pressure rotor shaft 22 and a seal support base 43b supporting the seal 43s. The seal 43s and the seal support base 43b are both annular about the axis Ar. The seal support base 43b is connected to the inside surface of the high-pressure rotor casing 30.

The low-pressure steam turbine unit 50 is disposed on the axially downstream side Dad of the high-pressure steam turbine unit 20. The low-pressure steam turbine unit 50 includes a low-pressure rotor 51 rotatable about the axis Ar, a low-pressure rotor casing 60 covering an outer periphery of the low-pressure rotor 51, a plurality of stator vane rows 66, a low-pressure steam pipe 70, a low-pressure steam valve 71, a low-pressure shaft sealing device 72, and an exhaust casing 75.

The low-pressure rotor 51 includes a low-pressure rotor shaft 52 extending in the axial direction Da about the axis Ar, and a plurality of rotor blade rows 55 provided on the low-pressure rotor shaft 52. The low-pressure steam turbine unit 50 according to the present embodiment has seven rotor blade rows 55. The plurality of rotor blade rows 55 are arranged in the axial direction Da at intervals from each other. Each of the plurality of rotor blade rows 55 includes a plurality of rotor blades 56 arranged in the circumferential direction Dc. The rotor blade 56 has a blade body 57 having a blade-shaped cross section and extending in the radial direction Dr perpendicular to the cross section, and a blade root 58 provided on the radially inner side Dri of the blade body 57. The low-pressure rotor shaft 52 is formed with a rotor blade row mounting portion 53 to which blade roots 58 of the plurality of rotor blades 56 constituting the rotor blade row 55 are mounted. The rotor blade row mounting portion 53 is an annular groove recessed from the outer periphery of the low-pressure rotor shaft 52 toward the radially inner side Dri.

Each of the plurality of stator vane rows 66 is disposed on the axially upstream side Dau of any one of the plurality of rotor blade rows 55.

Accordingly, the low-pressure steam turbine unit 50 according to the present embodiment has seven stator vane rows 66. That is, the low-pressure steam turbine unit 50 according to the present embodiment has seven cascade stages. One cascade stage is constituted by one stator vane row 66 and one rotor blade row 55. Each of the plurality of stator vane rows 66 includes a plurality of vane bodies 67 arranged in the circumferential direction Dc, and an outer ring 68 and an inner ring 69 which are annular about the axis Ar. The vane body 67 has a blade-shaped cross section and extends in the radial direction Dr perpendicular to the cross section. The outer ring 68 connects the ends, on the radially outer side Dro, of the plurality of vane bodies 67 arranged in the circumferential direction De to each other. The inner ring 69 connects the ends, on the radially inner side Dri, of the plurality of vane bodies 67 arranged in the circumferential direction De to each other.

The low-pressure rotor casing 60 includes a casing main body 61 and a diffuser 64.

The casing main body 61 covers a portion of the outer periphery of the low-pressure rotor 51 where the plurality of stator vane rows 66 and the plurality of rotor blade rows 55 are present in the axial direction Da. In the casing main body 61, one end of the low-pressure steam pipe 70 is connected to a position on the axially upstream side Dau of the stator vane row 66 on the most axially upstream side Dau, among the plurality of stator vane rows 66.

The other end of the low-pressure steam pipe 70 is connected to the high-pressure steam exhaust port 33 of the high-pressure rotor casing 30.

Accordingly, the low-pressure steam pipe 70 forms a downstream steam flow path 70p communicating with the annular high-pressure steam flow path 35.

The low-pressure steam pipe 70 is provided with the low-pressure steam valve 71. The low-pressure steam valve 71 can partition the downstream steam flow path 70p by being closed. In the casing main body 61, an extracted air port 63 penetrating from the inner peripheral side to the outer peripheral side of the casing main body 61 is formed at a substantially intermediate position in the axial direction Da. Specifically, the extracted air port 63 is formed at a position between the second cascade stage and the third cascade stage in the axial direction Da, among the seven cascade stages. One end of a first steam supply line 96a is connected to the extracted air port 63 of the casing main body 61.

The other end of the first steam supply line 96a is connected to a first steam utilization facility 95a.

The diffuser 64 is disposed on the axially downstream side Dad of the casing main body 61. The diffuser 64 forms an annular shape with respect to the axis Ar and forms a space that gradually extends toward the radially outer side Dro as it extends toward the axially downstream side Dad. The steam having passed through the rotor blade row 55 on the most axially downstream side Dad, among the plurality of rotor blade rows 55, flows into the annular space. The diffuser 64 has an outer diffuser (or steam guide, flow guide) 640 defining the edge of this annular space on the radially outer side Dro and an inner diffuser (or bearing cone) 64i defining the edge of this space on the radially inner side Dri. The outer diffuser 640 has an annular cross section perpendicular to the axis Ar, and gradually extends toward the radially outer side Dro as it extends toward the axially downstream side Dad. An end of the outer diffuser 640 on the axially upstream side Dau is connected to an end of the low-pressure rotor casing 60 on the axially downstream side Dad. The inner diffuser 64i has an annular cross section perpendicular to the axis Ar, and gradually extends toward the radially outer side Dro as it extends toward the axially downstream side Dad. An end of the inner diffuser 64i on the axially downstream side Dad is connected to the exhaust casing 75.

The exhaust casing 75 forms an exhaust space 76 into which the steam having passed through the inside of the diffuser 64 flows. The exhaust casing 75 has an exhaust port 77 for discharging the steam in the exhaust space 76 to a condenser 99.

An annular space between the inner peripheral side of the casing main body 61 and the outer peripheral side of the low-pressure rotor shaft 52 on the axially downstream side Dad of the low-pressure steam pipe 70 and on the axially upstream side Dau of the diffuser 64 and an annular space in the diffuser 64 form an annular low-pressure steam flow path 65 through which the low-pressure steam from the low-pressure steam pipe 70 flows.

The low-pressure shaft sealing device 72 is disposed on the inner peripheral side of the inner diffuser 64i. The low-pressure shaft sealing device 72 is a device that suppresses the low-pressure steam in the low-pressure rotor casing 60 flowing out from between the low-pressure rotor casing 60 and the low-pressure rotor shaft 52. The low-pressure shaft sealing device 72 includes a seal 72s facing the outside surface of the low-pressure rotor shaft 52 and a seal support base 72b supporting the seal 72s. The seal 72s and the seal support base 72b are both annular about the axis Ar. The seal support base 72b is connected to the inside surface of the inner diffuser 64i in the low-pressure rotor casing 60.

The high-pressure rotor 21 and the low-pressure rotor 51 are located on the same axis Ar, and are connected to each other to form a steam turbine rotor 11. The high-pressure rotor casing 30, the low-pressure rotor casing 60, and the exhaust casing 75 are connected to each other to form a steam turbine casing 15. An end of the steam turbine rotor 11 on the axially upstream side Dau protrudes from the inside of the steam turbine casing 15 to the axially upstream side Dau. Meanwhile, an end of the steam turbine rotor 11 on the axially downstream side Dad protrudes from the inside of the steam turbine casing 15 to the axially downstream side Dad. The steam turbine 10 of the present embodiment further includes a first bearing 16 and a second bearing 17 that rotatably support the steam turbine rotor 11. The first bearing 16 rotatably supports a portion of the steam turbine rotor 11 that protrudes from the inside of the steam turbine casing 15 to the axially upstream side Dau. The second bearing 17 rotatably supports a portion of the steam turbine rotor 11 that protrudes from the inside of the steam turbine casing 15 toward the axially downstream side Dad.

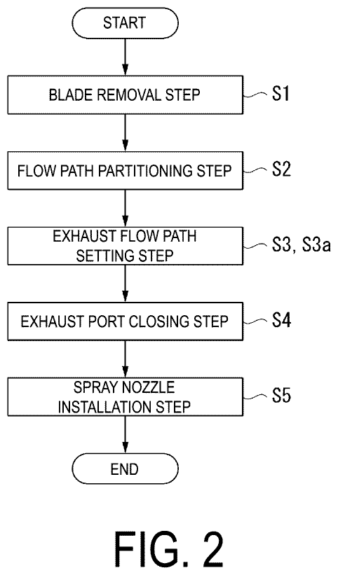

Now, a method for modifying the steam turbine 10 described above will be described in accordance with a flowchart illustrated in FIG. 2.

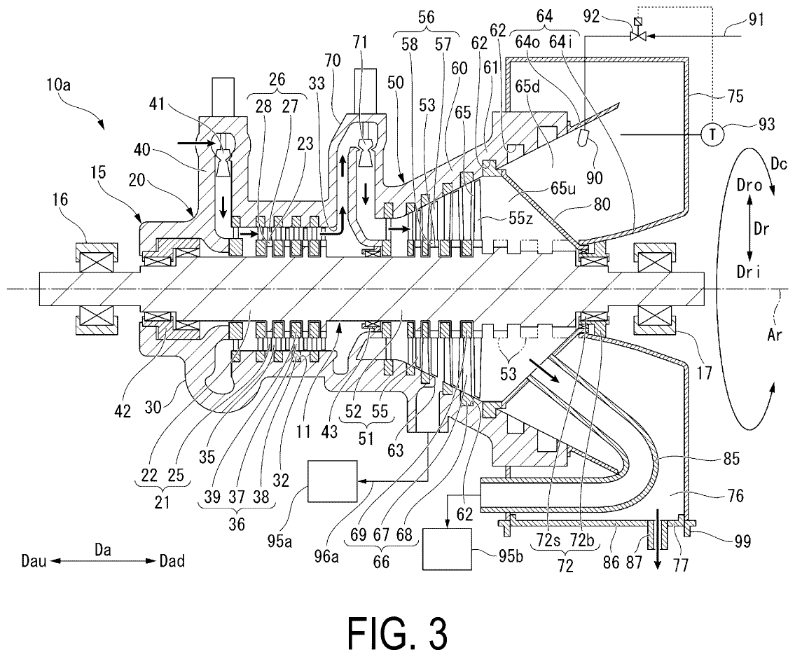

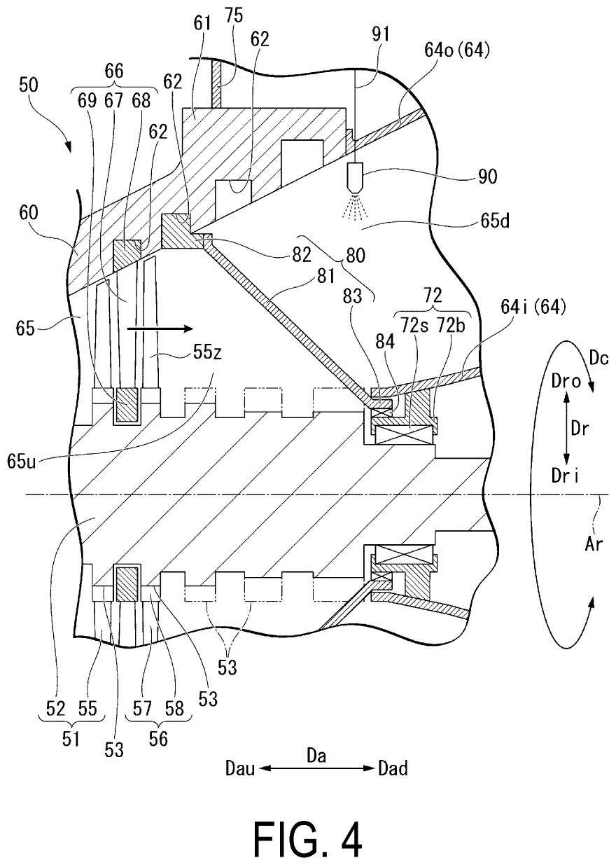

It is assumed that a certain user requests supply of steam having a first pressure and a first temperature, among the steam flowing through the steam turbine 10 before modification described above. It is assumed that the steam having passed through the fourth cascade stage in the low-pressure steam turbine unit 50 has the first pressure and the first temperature. In this case, as illustrated in FIGS. 3 and 4, the fourth cascade stage and all the cascade stages on the axially upstream side Dau of the fourth cascade stage in the low-pressure steam turbine unit 50 are left, while all the cascade stages on the axially downstream side Dad of the fourth cascade stage are removed (blade removal step S1). Specifically, the stator vane row 66 and the rotor blade row 55 constituting the fifth cascade stage, the stator vane row 66 and the rotor blade row 55 constituting the sixth cascade stage, and the stator vane row 66 and the rotor blade row 55 constituting the seventh cascade stage on the most axially downstream side Dad, among the plurality of cascade stages, are removed. As a result, the rotor blade row 55 constituting the fourth cascade stage becomes a final-stage rotor blade row 55z in a steam turbine 10a after modification.

Next, the annular low-pressure steam flow path 65 is partitioned at a position on the axially downstream side Dad of the final-stage rotor blade row 55z using a partition plate 80 as a partition member (flow path partitioning step S2). The partition plate 80 includes a partition plate main body 81, an outer end portion 82, and an inner end portion 83. The partition plate main body 81 has a cylindrical shape centered on the axis Ar, and has an inside diameter that gradually decreases toward the axially downstream side Dad. The outer end portion 82 is provided at an end of the partition plate main body 81 on the radially outer side Dro and on the axially upstream side Dau. The outer peripheral end portion forms an annular shape about the axis Ar. Further, the inner end portion 83 is provided at an end of the partition plate main body 81 on the radially inner side Dri and on the axially downstream side Dad. The inner end portion 83 forms an annular shape about the axis Ar. The inner end portion 83 has a partition plate seal 84 that seals between the partition plate 80 and the low-pressure shaft sealing device 72. The annular outer end portion 82 is fitted into a stator vane row mounting portion 62, which is an annular groove, to be mounted to the low-pressure rotor casing 60. The stator vane row mounting portion 62 is a stator vane row mounting portion to which the outer ring 68 of the stator vane row 66 constituting the fifth cascade stage removed in the blade removal step S1 was mounted, among the plurality of stator vane row mounting portions 62 of the low-pressure rotor casing 60. The partition plate seal 84 of the annular inner end portion 83 is brought into contact with the seal support base 72b of the annular low-pressure shaft sealing device 72.

The seal support base 72b has an outer surface extending in the axial direction Da. The partition plate seal 84 is brought into contact with the outer surface of the seal support base 72b so as to be movable in the axial direction Da with respect to the seal support base 72b.

In the present embodiment, the outer end portion 82 of the partition plate 80 is mounted using the stator vane row mounting portion 62 formed in the low-pressure rotor casing 60 of the steam turbine 10 before modification.

Therefore, it is possible to minimize modification of the low-pressure rotor casing 60 to which the outer end portion 82 of the partition plate 80 is mounted. Furthermore, in the present embodiment, the outer end portion 82 of the partition plate 80 is fitted into the stator vane row mounting portion 62 that is a groove recessed radially outward. Therefore, in the present embodiment, it is possible to suppress steam leakage from between the low-pressure rotor casing 60 and the outer end portion 82 of the partition plate 80.

In the present embodiment, the inner end portion 83 of the partition plate 80 is brought into contact with a stationary component having a portion along the outside surface of the low-pressure rotor shaft 52. Therefore, in the present embodiment, it is possible to suppress steam leakage from between the inner end portion 83 and the contact target compared to a case where the inner end portion 83 of the partition plate 80 is brought into contact with a rotating component.

The partition plate 80 extends in a direction including the radial direction Dr and the axial direction Da. As described above, the inner end portion 83 of the partition plate 80 is movable in the axial direction Da with respect to the low-pressure shaft sealing device 72. Accordingly, the inner end portion 83 of the partition plate 80 is movable in a direction including a component in the direction in which the partition plate 80 extends. Therefore, in the present embodiment, even when the partition plate 80 expands due to heat, the inner end portion 83 of the partition plate 80 moves to allow the expansion of the partition plate 80.

In the present embodiment, the inner end portion 83 of the partition plate 80 is brought into contact with the low-pressure shaft sealing device 72 which is a stationary component. However, the inner end portion 83 of the partition plate 80 may be in contact with the inner diffuser 64i. In this case, the stationary component with which the inner end portion 83 comes into contact includes the low-pressure shaft sealing device 72 and the inner diffuser 64i.

Next, in the low-pressure steam flow path 65, an exhaust flow path is set that can lead the steam in an upstream space 65u on the final-stage rotor blade row 55z side with respect to the position where the low-pressure steam flow path 65 is partitioned by the partition plate 80 to the outside of the low-pressure rotor casing 60 (exhaust flow path setting step S3). In the exhaust flow path setting step S3, an exhaust pipe (exhaust flow path forming portion) 85 in which an exhaust flow path is formed is provided. One end of the exhaust pipe 85 is connected to the partition plate 80, and the other end of the exhaust pipe 85 is connected to a second steam utilization facility 95b that requests the supply of steam. Accordingly, the exhaust pipe 85 forms a second steam supply line for feeding the steam in the upstream space 65u to the second steam utilization facility 95b.

Next, the exhaust port 77 of the exhaust casing 75 is closed by a closing plate 86 (exhaust port closing step S4). In the low-pressure steam flow path 65, there is a possibility that a part of the steam in the upstream space 65u flows into the downstream space 65d farther from the final-stage rotor blade row 55z than the position at which the low-pressure steam flow path 65 is partitioned by the partition plate 80 and form a drain in the downstream space 65d. Therefore, the closing plate 86 is preferably provided with a drain discharge pipe 87 for discharging a drain from the inside of the exhaust space 76 communicating with the downstream space 65d to the outside of the low-pressure steam turbine unit 50.

Next, a thermometer 93 capable of detecting the temperature of the downstream space 65d and a spray nozzle 90 capable of jetting cooling water to the downstream space 65d are provided (spray nozzle installation step S5). A cooling water line 91 is connected to the spray nozzle 90. The cooling water line 91 is provided with an adjustment valve 92 capable of adjusting the flow rate of the cooling water flowing through the cooling water line 91. The adjustment valve 92 is opened when the temperature detected by the thermometer 93 becomes equal to or higher than a predetermined temperature. Here, the predetermined temperature is a design temperature of the exhaust casing 75, for example. Therefore, when the temperature of the downstream space 65d becomes equal to or higher than the design temperature of the exhaust casing 75, the cooling water is jetted from the spray nozzle 90 to the downstream space 65d.

The temperature of the steam in the upstream space 65u in the low pressure steam flow path 65 is higher than the temperature of the steam having passed through the rotor blade row 55 on the most axially downstream side Dad in the steam turbine 10 before modification. The pressure of the steam in the upstream space 65u in the low-pressure steam flow path 65 is higher than the pressure of the steam having passed through the rotor blade row 55 on the most axially downstream side Dad in the steam turbine 10 before modification. In addition, the design temperature and the design pressure of the exhaust casing 75 are set in accordance with the temperature and the pressure of the steam having passed through the rotor blade row 55 on the most axially downstream side Dad in the steam turbine 10 before modification. Therefore, if a part of the steam in the upstream space 65u flows into the downstream space 65d and the exhaust space 76, there is a possibility that a problem such as damage to the exhaust casing 75 or the low-pressure shaft sealing device 72 may occur.

Thus, in the present embodiment, the downstream space 65d is provided with the spray nozzle 90 that can jet the cooling water so that the temperatures in the downstream space 65d and the exhaust space 76 do not rise to a predetermined temperature or higher and the pressures in the downstream space 65d and the exhaust space 76 do not rise to a predetermined pressure or higher, even if a part of the steam in the upstream space 65u flows into the downstream space 65d and the exhaust space 76.

This completes the modification of the steam turbine 10 according to the present embodiment. Among the steps described above, the exhaust flow path setting step S3, the exhaust port closing step S4, and the spray nozzle installation step S5 may be performed at any stage. For example, the spray nozzle installation step S5 may be executed before the blade removal step S1.

The steam turbine 10a obtained by the modification described above does not have all the cascade stages on the axially downstream side Dad of the fourth cascade stage in the low-pressure steam turbine unit 50 before the modification. However, in the steam turbine 10a obtained by the modification, the stator vane row mounting portion 62 to which the stator vane row 66 constituting the removed cascade stage was mounted and the rotor blade row mounting portion 53 to which the rotor blade row 55 constituting the removed cascade stage was mounted remain. In the steam turbine 10a obtained by the modification, the partition plate 80, the closing plate 86, the exhaust pipe 85, and the spray nozzle 90 have been added to the steam turbine 10 before the modification.

As described above, in the present embodiment, the steam from the steam turbine 10a is not fed to the condenser 99, but is fed to the second steam utilization facility 95b, and thus there is no heat loss occurring in the process of condensing the steam into water in the condenser 99, and the heat of the steam from the boiler can be effectively used.

In addition, in the present embodiment, it is possible to feed the steam having the pressure and the temperature corresponding to the request from the steam utilization side to the steam utilization facility by appropriately selecting the cascade stage to be removed.

In addition, in the present embodiment, it is possible to feed the steam having the pressure and the temperature corresponding to the request from the steam utilization side to the steam utilization facility by modification in one casing.

### Second Embodiment

A steam turbine modification method according to a second embodiment and a steam turbine obtained by executing the modification method will be described with reference to FIGS. 2, 5, and 6.

The steam turbine before modification according to the present embodiment is the steam turbine 10 described with reference to FIG. 1.

A method for modifying the steam turbine 10 according to the present embodiment will be described in accordance with the flowchart illustrated in FIG. 2.

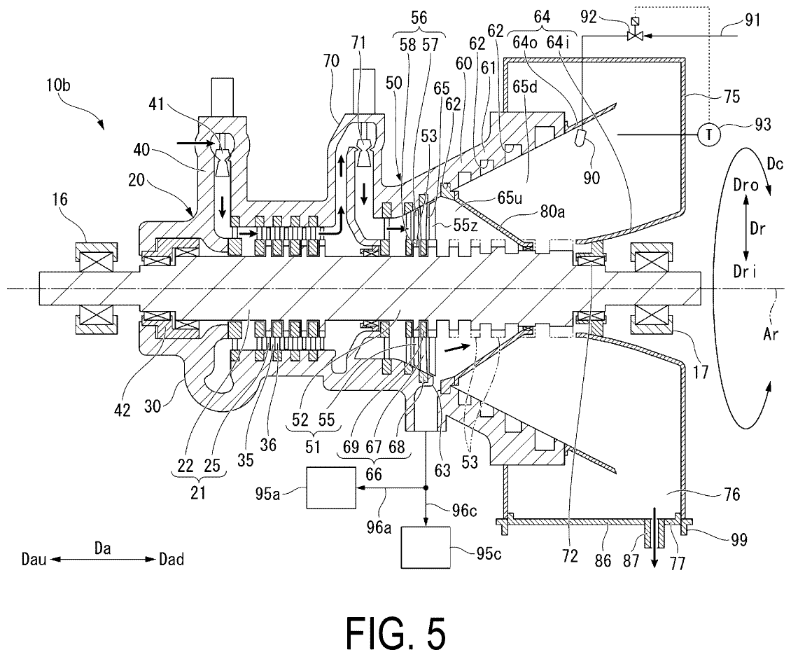

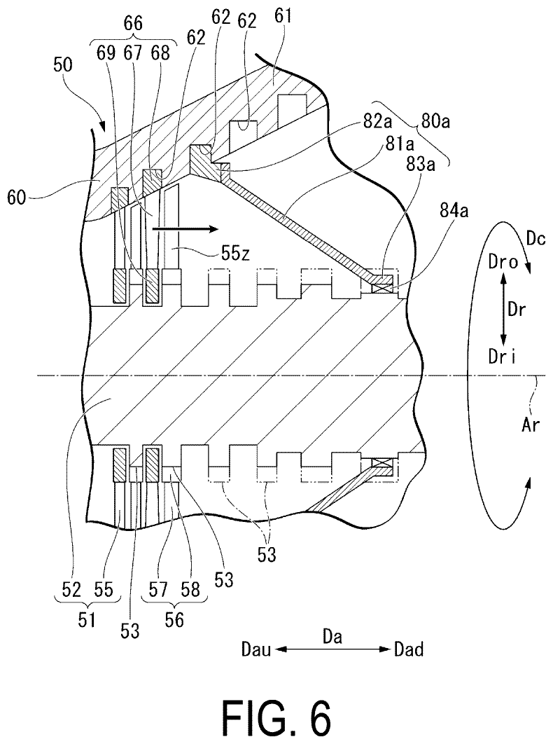

It is assumed that a certain user requests supply of steam having a second pressure and a second temperature, among the steam flowing through the steam turbine 10 before modification. It is assumed that the steam having passed through the second cascade stage in the low-pressure steam turbine unit 50 has the second pressure and the second temperature. In this case, as illustrated in FIGS. 5 and 6, the second cascade stage and all the cascade stages on the axially upstream side Dau of the second cascade stage in the low-pressure steam turbine unit 50 are left, while all the cascade stages on the axially downstream side Dad of the second cascade stage are removed (blade removal step S1). Specifically, the stator vane row 66 and the rotor blade row 55 constituting the third cascade stage, the stator vane row 66 and the rotor blade row 55 constituting the fourth cascade stage, the stator vane row 66 and the rotor blade row 55 constituting the fifth cascade stage, the stator vane row 66 and the rotor blade row 55 constituting the sixth cascade stage, and the stator vane row 66 and the rotor blade row 55 constituting the seventh cascade stage on the most axially downstream side Dad, among the plurality of cascade stages, are removed. As a result, the rotor blade row 55 constituting the second cascade stage becomes a final-stage rotor blade row 55z in a steam turbine 10b after modification.

Next, the annular low-pressure steam flow path 65 is partitioned at a position on the axially downstream side Dad of the final-stage rotor blade row 55z using a partition plate 80a as a partition member (flow path partitioning step S2). Similarly to the partition plate 80 according to the first embodiment, the partition plate 80a according to the present embodiment also includes a partition plate main body 81a, an outer end portion 82a, and an inner end portion 83a. The partition plate main body 81a has a cylindrical shape centered on the axis Ar, and has an inside diameter that gradually decreases toward the axially downstream side Dad. The outer end portion 82a is provided at an end of the partition plate main body 81a on the radially outer side Dro and on the axially upstream side Dau. The outer end portion 82a forms an annular shape about the axis Ar. Further, the inner end portion 83a is provided at an end of the partition plate main body 81a on the radially inner side Dri and on the axially downstream side Dad. The inner end portion 83a forms an annular shape about the axis Ar. Unlike the inner end portion 83a of the partition plate 80a in the first embodiment, the inner end portion 83a has a partition plate seal 84a that seals between the partition plate 80a and the low-pressure rotor shaft 52. The annular outer end portion 82a is fitted into a stator vane row mounting portion 62, which is an annular groove, to be mounted to the low-pressure rotor casing 60. The stator vane row mounting portion 62 is a stator vane row mounting portion 62 to which the outer ring 68 of the stator vane row 66 constituting the third cascade stage removed in the blade removal step S1 was mounted, among the plurality of stator vane row mounting portions 62 of the low-pressure rotor casing 60. The partition plate seal 84a of the annular inner end portion 83a is brought into contact with the outside surface of the low-pressure rotor shaft 52 so as to be movable in the axial direction Da with respect to the low-pressure rotor shaft 52.

The partition plate 80a according to the present embodiment also extends in a direction including the radial direction Dr and the axial direction Da. As described above, the inner end portion 83a of the partition plate 80a is movable in the axial direction Da with respect to the low-pressure rotor shaft 52. Accordingly, the inner end portion 83a of the partition plate 80a is movable in a direction including a component in the direction in which the partition plate 80a extends. Therefore, even when the partition plate 80a expands due to heat, the inner end portion 83a of the partition plate 80a moves to allow the expansion of the partition plate 80a.

Next, in the low-pressure steam flow path 65, an exhaust flow path is set that can lead the steam in an upstream space 65u on the final-stage rotor blade row 55z side with respect to the position where the low-pressure steam flow path 65 is partitioned by the partition plate 80a to the outside of the low-pressure rotor casing 60 (exhaust flow path setting step S3a). In the low-pressure rotor casing 60 of the steam turbine 10 before modification, as described above, the extracted air port 63 is provided at a position between the second cascade stage and the third cascade stage in the axial direction Da. The extracted air port 63 is a hole that can lead the steam in the upstream space 65u on the final-stage rotor blade row 55z side with respect to the position where the low-pressure steam flow path 65 is partitioned by the partition plate 80a to the outside of the low-pressure rotor casing 60. As described above, the first steam supply line 96a for feeding steam to the existing first steam utilization facility 95a is connected to the extracted air port 63. Thus, in the exhaust flow path setting step S3a, the extracted air port 63 and a part of the first steam supply line 96a are set as a part of the exhaust flow path. Further, in the exhaust flow path setting step S3a, the existing first steam supply line 96a and a new third steam utilization facility 95c are connected by a third steam supply line 96c. Therefore, in the present embodiment, the steam in the upstream space 65u can be fed to the first steam utilization facility 95a via the first steam supply line 96a, and can be fed to the third steam utilization facility 95c via the first steam supply line 96a and the third steam supply line 96c. Accordingly, in the present embodiment, the extracted air port 63, the first steam supply line 96a, and the third steam supply line 96c constitute an exhaust flow path forming portion.

Next, as in the first embodiment, the exhaust port 77 of the exhaust casing 75 is closed by a closing plate 86 (exhaust port closing step S4).

Next, as in the first embodiment, a thermometer 93 capable of detecting the temperature of the downstream space 65d and a spray nozzle 90 capable of jetting cooling water to the downstream space 65d are provided (spray nozzle installation step S5). A cooling water line 91 is connected to the spray nozzle 90. The cooling water line 91 is provided with an adjustment valve 92 capable of adjusting the flow rate of the cooling water flowing through the cooling water line 91. The adjustment valve 92 is opened when the temperature detected by the thermometer 93 becomes equal to or higher than a predetermined temperature.

This completes the modification of the steam turbine 10 according to the present embodiment.

The steam turbine 10b obtained by the modification described above does not have all the cascade stages on the axially downstream side Dad of the second cascade stage in the low-pressure steam turbine unit 50 before the modification. However, in the steam turbine 10b obtained by the modification, the stator vane row mounting portion 62 to which the stator vane row 66 constituting the removed cascade stage was mounted and the rotor blade row mounting portion 53 to which the rotor blade row 55 constituting the removed cascade stage was mounted remain. In the steam turbine 10b obtained by the modification, the partition plate 80a, the closing plate 86, and the spray nozzle 90 have been added to the steam turbine 10 before the modification.

As described above, also in the present embodiment, as in the first embodiment, the steam from the steam turbine 10b is not fed to the condenser 99, but is fed to the third steam utilization facility 95c, and thus there is no heat loss occurring in the process of condensing the steam into water in the condenser 99, and the heat of the steam from the boiler can be effectively used.

Further, also in the present embodiment, as in the first embodiment, it is possible to feed the steam having the pressure and the temperature corresponding to the request from the steam utilization side to the steam utilization facility by appropriately selecting the cascade stage to be removed.

In the present embodiment, steam is fed to the new third steam utilization facility 95c in addition to the existing first steam utilization facility 95a. However, when there is a request to increase the flow rate of steam from the side of the existing first steam utilization facility 95a, substantially all of the steam in the upstream space 65u described above may be fed to the first steam utilization facility 95 a via the first steam supply line 96a.

In this case, in the exhaust flow path setting step S3a, it is not necessary to provide the third steam supply line 96c, and the actual work in the exhaust flow path setting step S3a is eliminated. Accordingly, in this case, the exhaust flow path setting step S3a is unnecessary.

### Third Embodiment

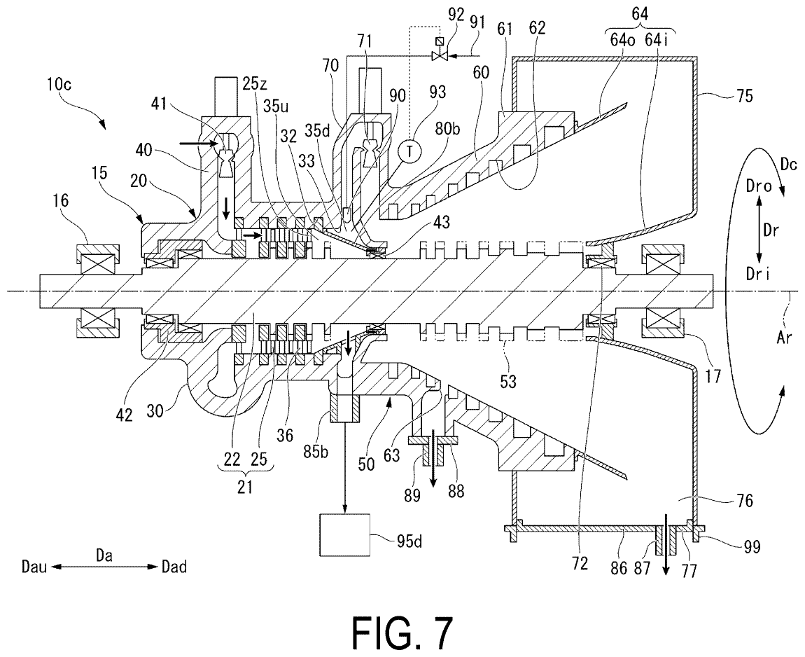

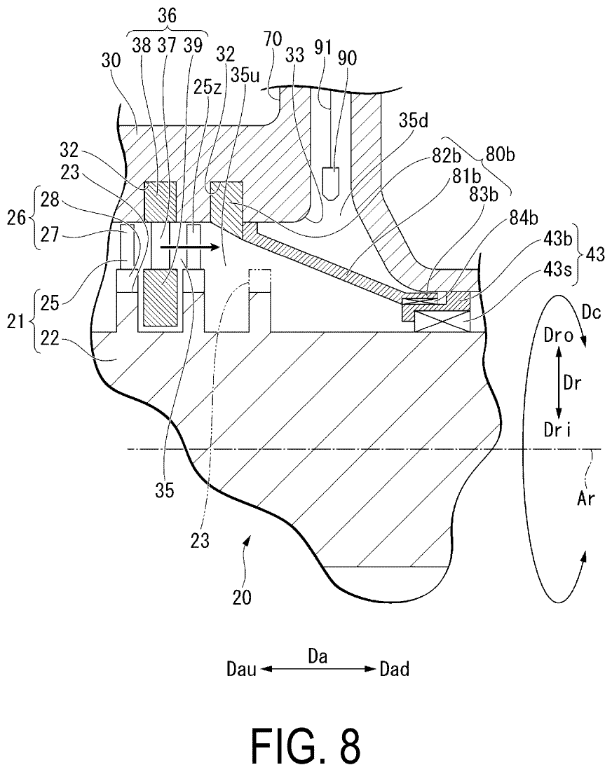

A steam turbine modification method according to a third embodiment and a steam turbine obtained by executing the modification method will be described with reference to FIGS. 7 and 8.

The steam turbine before modification according to the present embodiment is the steam turbine 10 described with reference to FIG. 1.

It is assumed that a certain user requests supply of steam having a third pressure and a third temperature, among the steam flowing through the steam turbine 10 before modification. It is assumed that the steam having passed through the third cascade stage in the high-pressure steam turbine unit 20 has the third pressure and the third temperature. In this case, as illustrated in FIGS. 7 and 8, the third cascade stage and all the cascade stages on the axially upstream side Dau of the third cascade stage in the high-pressure steam turbine unit 20 are left, while all the cascade stages on the axially downstream side Dad of the third cascade stage are removed (blade removal step S1).

Specifically, the stator vane row 36 and the rotor blade row 25 constituting the fourth cascade stage are removed. Further, the stator vane rows 66 and the rotor blade rows 55 constituting all the cascade stages in the low-pressure steam turbine unit 50 are removed. As a result, the rotor blade row 25 constituting the third cascade stage becomes a final-stage rotor blade row 25z in a steam turbine 10c after modification.

Next, the annular high-pressure steam flow path 35 is partitioned at a position on the axially downstream side Dad of the final-stage rotor blade row 25z using a partition plate 80b as a partition member (flow path partitioning step S2). Similarly to the partition plate 80 according to the first embodiment, the partition plate 80b according to the present embodiment also includes a partition plate main body 81b, an outer end portion 82b, and an inner end portion 83b. The partition plate main body 81b has a cylindrical shape centered on the axis Ar, and has an inside diameter that gradually decreases toward the axially downstream side Dad. The outer end portion 82b is provided at an end of the partition plate main body 81b on the radially outer side Dro and on the axially upstream side Dau. The outer end portion 82b forms an annular shape about the axis Ar. Further, the inner end portion 83b is provided at an end of the partition plate main body 81b on the radially inner side Dri and on the axially downstream side Dad. The inner end portion 83b forms an annular shape about the axis Ar. The inner end portion 83b has a partition plate seal 84b that seals between the partition plate 80b and the intermediate shaft sealing device 43.

The annular outer end portion 82b is fitted into a stator vane row mounting portion 32, which is an annular groove, to be mounted to the high-pressure rotor casing 30. The stator vane row mounting portion 32 is a stator vane row mounting portion 32 to which the outer ring 38 of the stator vane row 36 constituting the fourth cascade stage removed in the blade removal step S1 was mounted, among the plurality of stator vane row mounting portions 32 of the high-pressure rotor casing 30. The partition plate seal 84b of the annular inner end portion 83b is brought into contact with the seal support base 43b of the intermediate shaft sealing device 43 so as to be movable in the axial direction Da with respect to the intermediate shaft sealing device 43.

In the present embodiment, the inner end portion 83b of the partition plate 80b is brought into contact with the intermediate shaft sealing device 43 which is a stationary component. However, the inner end portion 83b of the partition plate 80b may be brought into contact with the vicinity of a portion to which the intermediate shaft sealing device 43 is connected in the high-pressure rotor casing 30. In this case, the stationary component with which the inner end portion 83b comes into contact includes the low-pressure shaft sealing device 72 and the high-pressure rotor casing 30.

The partition plate 80b according to the present embodiment also extends in a direction including the radial direction Dr and the axial direction Da. As described above, the inner end portion 83b of the partition plate 80b is movable in the axial direction Da with respect to the intermediate shaft sealing device 43. Accordingly, the inner end portion 83b of the partition plate 80b is movable in a direction including a component in the direction in which the partition plate 80b extends. Therefore, even when the partition plate 80b expands due to heat, the inner end portion 83b of the partition plate 80b moves to allow the expansion of the partition plate 80b.

Next, in the high-pressure steam flow path 35, an exhaust flow path is set that can lead the steam in an upstream space 35u on the final-stage rotor blade row 25z side with respect to the position where the high-pressure steam flow path 35 is partitioned by the partition plate 80b to the outside of the high-pressure rotor casing 30 (exhaust flow path setting step S3). In the exhaust flow path setting step S3, an exhaust pipe (exhaust flow path forming portion) 85b in which an exhaust flow path is formed is provided. One end of the exhaust pipe 85b is connected to the partition plate 80b, and the other end of the exhaust pipe 85b is connected to a fourth steam utilization facility 95d that requests the supply of steam. Accordingly, the exhaust pipe 85b forms a fourth steam supply line for feeding the steam in the upstream space 35u to the fourth steam utilization facility 95d.

Next, as in the first embodiment, the exhaust port 77 of the exhaust casing 75 is closed by a closing plate 86 (exhaust port closing step S4). Further, in the exhaust port closing step S4, a blind flange 88 is provided in the first steam supply line 96a connected to the extracted air port 63 of the low-pressure rotor casing 60 so that steam does not flow through the inside of the first steam supply line 96a. The blind flange 88 is preferably provided with a drain discharge pipe 89, as with the closing plate 86.

Next, as in the first embodiment, a thermometer 93 capable of detecting the temperature of the downstream space 35d and a spray nozzle 90 capable of jetting cooling water to the downstream space 35d are provided (spray nozzle installation step S5). A cooling water line 91 is connected to the spray nozzle 90. The cooling water line 91 is provided with an adjustment valve 92 capable of adjusting the flow rate of the cooling water flowing through the cooling water line 91. The adjustment valve 92 is opened when the temperature detected by the thermometer 93 becomes equal to or higher than a predetermined temperature.

This completes the modification of the steam turbine 10 according to the present embodiment.

The steam turbine 10c obtained by the modification described above does not have all the cascade stages on the axially downstream side Dad of the third cascade stage in the high-pressure steam turbine unit 20 before the modification. However, in the steam turbine 10c obtained by the modification, the stator vane row mounting portion 32, 62 to which the stator vane row 36, 66 constituting the removed cascade stage was mounted and the rotor blade row mounting portion 23, 53 to which the rotor blade row 25, 55 constituting the removed cascade stage was mounted remain. In addition, in the steam turbine 10c obtained by the modification, the partition plate 80b, the closing plate 86, the exhaust pipe 85b, and the spray nozzle 90 have been added to the steam turbine 10 before the modification.

As described above, also in the present embodiment, as in the first embodiment, the steam from the steam turbine 10c is not fed to the condenser 99, but is fed to the fourth steam utilization facility 95d, and thus there is no heat loss occurring in the process of condensing the steam into water in the condenser 99, and the heat of the steam from the boiler can be effectively used.

Further, also in the present embodiment, as in the first embodiment, it is possible to feed the steam having the pressure and the temperature corresponding to the request from the steam utilization side to the steam utilization facility by appropriately selecting the cascade stage to be removed.

### Modification Examples

The inner end portion 83, 83a, 83b of the partition plate 80, 80a, 80b in each of the above embodiments is movable in the axial direction Da in order to allow extension of the partition plate 80, 80a, 80b expanding in a direction including the radial direction Dr and the axial direction Da. However, the movable direction of the inner end portion 83, 80a, 80b of the partition plate 80, 83a, 83b may be any direction as long as it is a direction including the radial direction Dr and the axial direction Da in which the partition plate 80, 80a, 80b expands. Therefore, the inner end portions 83, 80a, 80b of the partition plates 80, 83a, 83b may be movable in the radial direction Dr.

In the second embodiment, the inner end portion 80a of the partition plate 83a is in contact with the low-pressure rotor shaft 52. However, the inner end portion 80a of the partition plate 83a may be brought into contact with the stationary component as in the first embodiment. Further, in the first embodiment and the third embodiment, the inner end portion 83, 83b of the partition plate 80, 80b is in contact with the stationary component. However, the inner end portion 83, 83b of the partition plate 80, 80b may be in contact with the rotor shaft 22, 52 as in the second embodiment.

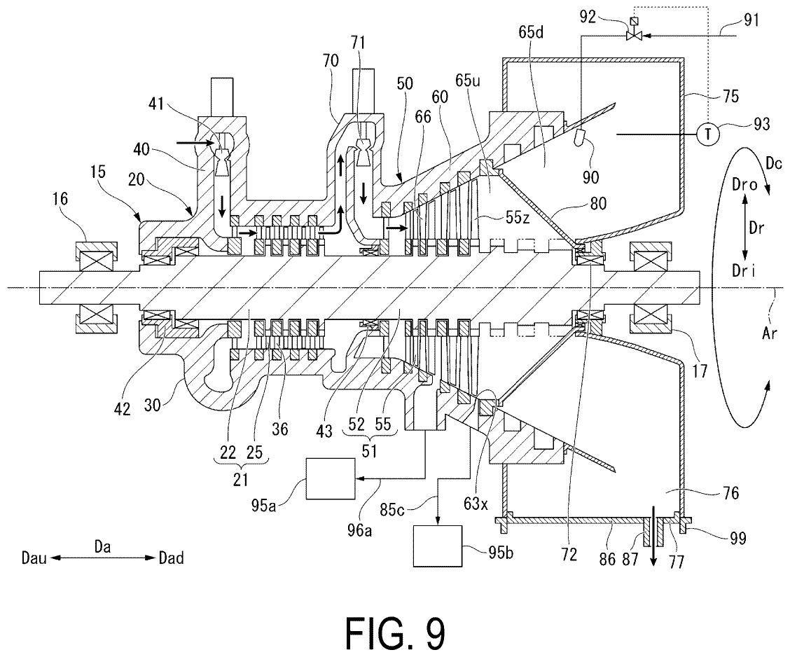

In the first embodiment and the third embodiment, the exhaust pipe 85, 85b is connected to the partition plate 80, 80b. However, the exhaust pipe 85, 85b may not be connected to the partition plate 80, 80b as long as the steam in the upstream space 35u, 65u can be led to the outside of the rotor casing 30, 60. For example, as illustrated in FIG. 9, the low-pressure rotor casing 60 may be provided with a port 63x through which the steam in the upstream space 65u can be discharged to the outside of the low-pressure rotor casing 60, and an exhaust pipe 85c may be connected to the port 63x. The port 63x capable of discharging the steam in the upstream space 65u to the outside of the low-pressure rotor casing 60 may be formed in advance in the low-pressure rotor casing 60 in order to discharge steam drain generated in the upstream space 65u, for example.

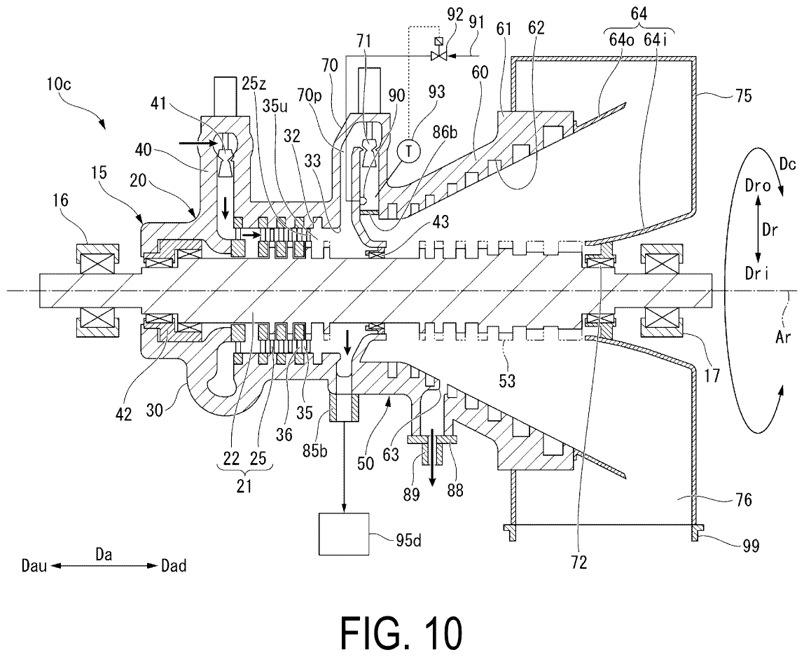

In the flow path partitioning step S2 of the third embodiment, the annular high-pressure steam flow path 35 is partitioned at a position on the axially downstream side Dad of the final-stage rotor blade row 25z using the partition plate 80b as a partition member. However, as illustrated in FIG. 10, in the flow path partitioning step S2, the downstream steam flow path 70p communicating with the high-pressure steam flow path 35 may be partitioned by closing the low-pressure steam valve 71, instead of partitioning the annular high-pressure steam flow path 35 using the partition plate 80b. Accordingly, in this case, the low-pressure steam valve 71 serves as a partition member. In this case, the downstream steam flow path 70p may be closed by a closing plate 86b at a position on the downstream side in the steam flow direction with respect to the position where the low-pressure steam valve 71 is provided in the downstream steam flow path 70p, instead of closing the exhaust port 77 of the exhaust casing 75 using the closing plate 86. When the downstream steam flow path 70p is provided with the closing plate 86b, the closing plate 86b is preferably provided with a drain discharge pipe, as with the closing plate 86. In this case, a thermometer 93 may be provided in a space downstream of the low-pressure steam valve 71 and upstream of the closing plate 86b in the downstream steam flow path 70p, and a spray nozzle 90 capable of jetting cooling water may be provided in the space.

In each of the above embodiments, there is only one exhaust flow path for leading the steam in the upstream space 35u, 65u to the outside of the rotor casing 30, 60. However, there may be a plurality of exhaust flow paths. For example, a single exhaust pipe 85 in which an exhaust flow path is formed is connected to the partition plate 80 in the first embodiment, a plurality of exhaust pipes 85 may be connected to the partition plate 80. In this case, the exhaust pipes 85 are connected at the positions of 3 o'clock and 9 o'clock when viewed from the axial direction Da, for example.

In the steam turbine 10a, 10b, and 10c after modification in the above embodiments, the stator vane row mounting portions 32, 62 to which the stator vane rows 36, 66 constituting the cascade stages removed by the modification were mounted and the rotor blade row mounting portions 23, 53 to which the rotor blade rows 25, 55 constituting the cascade stages removed by the modification were mounted remain. However, in the process of the modification, a portion of the rotor casing 30, 60 with the stator vane row mounting portions 32, 62 to which the stator vane rows 36, 66 are not mounted may be removed. Further, a portion of the rotor shaft 22, 52 with the rotor blade row mounting portions 23, 53 to which the rotor blade rows 25, 55 are not mounted may be removed.

In the embodiment described above, the exhaust port closing step S4 and the spray nozzle installation step S5 are executed. However, the exhaust port closing step S4 and the spray nozzle installation step S5 may be omitted. In particular, in the case of the third embodiment, almost no steam flows to the downstream side of the low-pressure steam valve 71 if the low-pressure steam valve 71 is closed after the modification, and therefore the exhaust port closing step S4 and the spray nozzle installation step S5 may be omitted.

The present disclosure is not limited to the embodiments described above. Various additions, changes, substitutions, partial deletions, and the like can be made without departing from the scope and the spirit of the present invention derived from the contents and equivalents thereof defined in the claims.

### Supplementary Notes

The modification method for a steam turbine 10 according to the above embodiments and modification examples can be understood as follows, for example.
(1) A Method for Modifying a Steam Turbine According to a First Aspect is Directed to the Following Steam Turbine 10.

The steam turbine 10 to be modified includes: a rotor 21, 51 rotatable about an axis Ar; a rotor casing 30, 60 covering an outer peripheral side of the rotor 21, 51; and a plurality of stator vane rows 36, 66 provided on an inner peripheral side of the rotor casing 30, 60 and arranged in an axial direction Da in which the axis Ar extends. The rotor 21, 51 includes a rotor shaft 22, 52 extending in the axial direction Da about the axis Ar, and a plurality of rotor blade rows 25, 55 provided on the rotor shaft 22, 52. Each of the plurality of rotor blade rows 25, 55 is disposed on an axially downstream side Dad, in the axial direction Da, of any one of the plurality of stator vane rows 36, 66.

The method for modifying a steam turbine 10 includes: a blade removal step S1 of removing a plurality of rotor blade rows 25, 55 including a rotor blade row 25, 55 on a most axially downstream side Dad and adjacent to each other in the axial direction Da, or the rotor blade row 25, 55 on the most axially downstream side Dad, among the plurality of rotor blade rows 25, 55, and removing a stator vane row 36, 66 adjacent to each of the one or more rotor blade rows 25, 55 to be removed on an axially upstream side Dau, in the axial direction Da, of the one or more rotor blade rows 25, 55, among the plurality of stator vane rows 36, 66, and thus at least a rotor blade row 25, 55 on the most axially upstream side Dau, among the plurality of rotor blade rows 25, 55, remains and at least a stator vane row 36, 66 on the most axially upstream side Dau, among the plurality of stator vane rows 36, 66, remains; and a flow path partitioning step S2 of partitioning a steam flow path 35, 65 having an annular shape and formed between the inner peripheral side of the rotor casing 30, 60 and an outer peripheral side of the rotor shaft 22, 52, or a downstream steam flow path 70p communicating with the steam flow path 35, at a position on the axially downstream side Dad of a final-stage rotor blade row 25z, 55z being the rotor blade row 25, 55 on the most axially downstream side Dad, among the one or more rotor blade rows 25, 55 remaining after the blade removal step S1.

In the present aspect, the steam from the steam turbine 10 is not fed to the condenser 99, and the steam in the upstream space 35u, 65u on the final-stage rotor blade row 25z, 55z side of the position where the steam flow path 35, 65 is partitioned can be fed to the steam utilization facility. Therefore, in the present aspect, there is no heat loss occurring in the process of condensing the steam into water in the condenser 99, and the heat of the steam from the boiler can be effectively used.

In addition, in the present aspect, it is possible to feed the steam having the pressure and the temperature corresponding to the request from the steam utilization side to the steam utilization facility by appropriately selecting the cascade stage to be removed.
(2) The Method for Modifying a Steam Turbine According to the Second Aspect Is

the method for modifying a steam turbine 10 according to the first aspect, further including an exhaust flow path setting step S3 of setting an exhaust flow path capable of leading steam in a space on a side of the final-stage rotor blade row 25z, 55z with respect to a position where the steam flow path 35, 65 or the downstream steam flow path 70p is partitioned in the steam flow path 35, 65 to outside of the rotor casing 30, 60. In the exhaust flow path setting step S3, a pipe 85, 85b in which the exhaust flow path is formed is provided.
(3) The Method for Modifying a Steam Turbine According to the Third Aspect Is

the method for modifying a steam turbine 10 according to the first aspect, in which the rotor casing 60 is provided in advance with an extracted air port 63 capable of leading steam in a space on a side of the final-stage rotor blade row 25z, 55z with respect to a position where the steam flow path 35, 65 or the downstream steam flow path 70p is partitioned to outside of the rotor casing 60. The method further includes an exhaust flow path setting step S3a of setting, in the steam flow path 35, 65 or the downstream steam flow path 70p, an exhaust flow path capable of leading steam in the space on the side of the final-stage rotor blade row 55z with respect to the position where the steam flow path 35, 65 or the downstream steam flow path 70p is partitioned to outside of the rotor casing 60. In the exhaust flow path setting step S3a, the extracted air port 63 is set as at least a part of the exhaust flow path.
(4) The Method for Modifying a Steam Turbine According to the Fourth Aspect Is

the method for modifying a steam turbine 10 according to any one of the first to third aspects, in which the steam turbine 10 includes a steam valve 71 capable of partitioning the downstream steam flow path 70p. In the flow path partitioning step S2, the downstream steam flow path 70p is partitioned by closing the steam valve 71.
(5) The Method for Modifying a Steam Turbine According to the Fifth Aspect Is

the method for modifying a steam turbine 10 according to any one of the first to third aspects, in which in the flow path partitioning step S2, the steam flow path 35, 65 is partitioned using a partition plate 80, 80a, 80b. The partition plate 80, 80a, 80b includes an inner end portion 83, 83a, 83b that is an end portion on a radially inner side Dri in a radial direction Dr with respect to the axis Ar, and an outer end portion 82, 82a, 82b that is an end portion on a radially outer side Dro in the radial direction Dr. In the flow path partitioning step S2, the outer end portion 82, 82a, 82b of the partition plate 80, 80a, 80b is connected to the rotor casing 30, 60.
(6) the Method for Modifying a Steam Turbine According to the Sixth Aspect Is

the method for modifying a steam turbine 10 according to the fifth aspect, in which in the flow path partitioning step S2, the outer end portion 82, 82a, 82b of the partition plate 80, 80a, 80b is connected to a stator vane row mounting portion 32, 62 to which the stator vane row 36, 66 on the most axially upstream side Dau, among the one or more stator vane rows 36, 66 removed in the blade removal step SI, is mounted, in the rotor casing 30, 60.

In the present aspect, the outer end portion 82, 82a, 82b of the partition plate 80, 80a, 80b is mounted using the stator vane row mounting portion 32, 62 formed in the rotor casing 30, 60 of the steam turbine 10 before modification. Therefore, in the present aspect, it is possible to minimize modification of the rotor casing 30, 60 to which the outer end portion 82b of the partition plate 80, 80a, 80b is mounted.
(7) The Method for Modifying a Steam Turbine According to the Seventh Aspect Is

the method for modifying a steam turbine 10 according to the fifth or sixth aspect, in which the steam turbine 10 includes a stationary component disposed at a position on the axially downstream side Dad of the final-stage rotor blade row 25z, 55z and including a portion along an outside surface of the rotor shaft 22, 52.

In the flow path partitioning step S2, the inner end portion 83, 83b of the partition plate 80, 80b is brought into contact with the stationary component.

In the present aspect, the inner end portion 83, 83b of the partition plate 80, 80b is brought into contact with a stationary component including a portion along the outside surface of the rotor shaft 22, 52. Therefore, in the present aspect, it is possible to suppress steam leakage from between the inner end portion 83, 83b and the contact target compared to a case where the inner end portion 83, 83b of the partition plate 80, 80b is brought into contact with a rotating component.
(8) The Method for Modifying a Steam Turbine According to the Eighth Aspect Is

the method for modifying a steam turbine 10 according to the seventh aspect, in which in the flow path partitioning step S2, the inner end portion 83, 83b of the partition plate 80, 80b is brought into contact with the stationary component such that the inner end portion 83, 83b of the partition plate 80, 80b is movable in a direction including a component in a direction in which the partition plate 80, 80b extends.

In the present aspect, the inner end portion 83, 83b of the partition plate 80, 80b is brought into contact with the stationary component such that the inner end portion 83, 83b of the partition plate 80, 80b is movable in a direction including a component in a direction in which the partition plate 80, 80b extends. Therefore, in the present aspect, even when the partition plate 80, 80b expands due to heat, the inner end portion 83, 83b of the partition plate 80, 80b moves to allow the expansion of the partition plate 80, 80b.
(9) The Method for Modifying a Steam Turbine According to the Ninth Aspect Is

the method for modifying a steam turbine 10 according to the seventh or eighth aspect, in which the stationary component is a shaft sealing device 42, 43 that faces the outside surface of the rotor shaft 22, 52 and is capable of suppressing outflow of steam to the axially downstream side Dad of the shaft sealing device.
(10) The Method for Modifying a Steam Turbine According to the Tenth Aspect Is

the method for modifying a steam turbine 10 according to any one of the first to ninth aspects, in which the steam turbine 10 includes an exhaust casing 75 capable of leading steam having flowed through the steam flow path 65 to a condenser 99. The method further includes an exhaust port closing step S4 of closing an exhaust port 77 through which steam is discharged to the condenser 99 in the exhaust casing 75.

In the present aspect, even if a part of the steam in the upstream space 65u on the final-stage rotor blade row 55z side of the position where the steam flow path 65 is partitioned flows into the downstream space 65d on the side farther from the final-stage rotor blade row 55z than the position where the steam flow path 65 is partitioned, it is possible to prevent this steam from flowing into the condenser 99.
(11) The method for Modifying a Steam Turbine According to the Eleventh Aspect Is

the method for modifying a steam turbine 10 according to any one of the first to tenth aspects, further including a spray nozzle installation step S5 of providing a spray nozzle 90 capable of jetting cooling water in a space on a side farther from the final-stage rotor blade row 25z, 55z than a position where the steam flow path 35, 65 is partitioned in the steam flow path 35, 65.

The temperature of the steam in the upstream space 35u, 65u in the steam flow path 35, 65 is higher than the temperature of the steam having passed through the rotor blade row 25, 55 on the most axially downstream side Dad in the steam turbine 10 before modification. The pressure of the steam in the upstream space 35u, 65u in the steam flow path 35, 65 is higher than the pressure of the steam having passed through the rotor blade row 25, 55 on the most axially downstream side Dad in the steam turbine 10 before modification. Therefore, if a part of the steam in the upstream space 35u, 65u flows into the downstream space 35d, 65d, there is a possibility that a casing or the like defining the downstream space 35d, 65d or a further downstream space may be damaged. Thus, in the present aspect, the downstream space 35d, 65d is provided with the spray nozzle 90 that can jet the cooling water so that the temperatures in the downstream space 35d, 65d do not rise to a predetermined temperature or higher and the pressures in the downstream space 35d, 65d do not rise to a predetermined pressure or higher, even if a part of the steam in the upstream space 35u, 65u flows into the downstream space 35d, 65d.

The steam turbine 10a, 10b, 10c after modification according to the above embodiments and modification examples can be understood as follows, for example.
(12) A Steam Turbine According to a Twelfth Aspect Includes:

a rotor 21, 51 rotatable about an axis Ar; a rotor casing 30, 60 covering an outer peripheral side of the rotor 21, 51; one stator vane row 36, 66 provided on an inner peripheral side of the rotor casing 30, 60 or a plurality of stator vane rows 36, 66 provided on the inner peripheral side of the rotor casing 30, 60 and arranged in an axial direction Da in which the axis Ar extends; a partition member 80, 80a, 80b, 71 that partitions a steam flow path 35, 65 or a downstream steam flow path 70p communicating with the steam flow path 35; and an exhaust flow path forming portion in which an exhaust flow path capable of leading steam to outside of the rotor casing 30, 60 is formed. The rotor 21, 51 includes a rotor shaft 22, 52 extending in the axial direction Da about the axis Ar, and one or more rotor blade rows 25, 55 provided on the rotor shaft 22, 52. Each of the one or more rotor blade rows 25, 55 is disposed on an axially downstream side Dad, in the axial direction Da, of any one of the one or more stator vane rows 36, 66. The steam flow path 35, 65 is an annular flow path formed between the inner peripheral side of the rotor casing 30, 60 and an outer peripheral side of the rotor shaft 22, 52. The partition member 80, 80a, 80b, 71 partitions the steam flow path 35, 65 or the downstream steam flow path 70p at a position on the axially downstream side Dad of a final-stage rotor blade row 25z, 55z being a rotor blade row 25, 55 on a most axially downstream side Dad, among the one or more rotor blade rows 25, 55. The exhaust flow path is capable of leading steam in a space on a side of the final-stage rotor blade row 25z, 55z with respect to a position where the steam flow path 35, 65 or the downstream steam flow path 70p is partitioned in the steam flow path 35, 65 or the downstream steam flow path 70p to outside of the rotor casing 30, 60.
(13) The Steam Turbine According to a Thirteenth Aspect Is

the steam turbine 10a, 10b, 10c according to the twelfth aspect, in which the rotor casing 30, 60 includes a stator vane row mounting portion 32, 62 to which a stator vane row 36, 66 is mountable but no stator vane row 36, 66 is mounted, the stator vane row mounting portion being located on the axially downstream side Dad of the final-stage rotor blade row 25z, 55z. The rotor shaft 22, 52 includes a rotor blade row mounting portion 23, 53 to which a rotor blade row 25, 55 is mountable but no rotor blade row 25, 55 is mounted, the rotor blade row mounting portion being located on the axially downstream side Dad of the final-stage rotor blade row 25z, 55z.
(14) The Steam Turbine According to a Fourteenth Aspect Is

the steam turbine 10a, 10b, 10c according to the twelfth or thirteenth aspect, further including a steam valve 71 capable of partitioning the downstream steam flow path 70p as the partition member 80, 80a, 80b, 71. The steam valve 71 is closed when the downstream steam flow path 70p is partitioned.
(15) The Steam Turbine According to a Fifteenth Aspect Is

the steam turbine 10a, 10b, 10c according to the twelfth or thirteenth aspect, further including a partition plate 80, 80a, 80b that partitions the steam flow path 35, 65 as the partition member 80, 80a, 80b, 71. The partition plate 80, 80a, 80b includes an inner end portion 83, 83a, 83b that is an end portion on a radially inner side Dri in a radial direction Dr with respect to the axis Ar, and an outer end portion 82b that is an end portion on a radially outer side Dro in the radial direction Dr. The outer end portion 82b of the partition plate 80, 80a, 80b is connected to the rotor casing 30, 60.
(16) The Steam Turbine According to a Sixteenth Aspect Is

the steam turbine 10a, 10b, 10c according to the thirteenth aspect, in which the partition plate 80, 80a, 80b includes an inner end portion 83, 83a, 83b that is an end portion on a radially inner side Dri in a radial direction Dr with respect to the axis Ar, and an outer end portion 82b that is an end portion on a radially outer side Dro in the radial direction Dr. The outer end portion 82b of the partition plate 80, 80a, 80b is connected to the stator vane row mounting portion 32, 62 of the rotor casing 30, 60.
(17) The Steam Turbine According to a Seventeenth Aspect Is

the steam turbine 10a, 10c according to the fifteenth or sixteenth aspect, further including a stationary component disposed at a position on the axially downstream side Dad of the final-stage rotor blade row 25z, 55z and including a portion along an outside surface of the rotor shaft 22, 52. The inner end portion 83, 83b of the partition plate 80, 80b is in contact with the stationary component.
(18) The Steam Turbine According to an Eighteenth Aspect Is

the steam turbine 10a, 10c according to the seventeenth aspect, in which the inner end portion 83, 83b of the partition plate 80, 80b is in contact with the stationary component such that the inner end portion 83, 83b of the partition plate 80, 80b is movable in a direction including a component in a direction in which the partition plate 80, 80b extends.
(19) The steam turbine according to a nineteenth aspect is

the steam turbine 10a, 10c according to the seventeenth or eighteenth aspect, in which the stationary component is a shaft sealing device 42, 43 that faces the outside surface of the rotor shaft 22, 52 and suppresses outflow of steam to the axially downstream side Dad of the shaft sealing device.
(20) The Steam Turbine According to a Twentieth Aspect Is

the steam turbine 10a, 10b, 10c according to any one of the twelfth to nineteenth aspects, further including: an exhaust casing 75 capable of discharging steam having flowed through the steam flow path 35, 65 to a condenser 99; and a closing plate 86 that closes an exhaust port 77 capable of discharging steam to the condenser 99 in the exhaust casing 75.
(21) The Steam Turbine According to a Twenty-First Aspect Is

the steam turbine 10a, 10b, 10c according to any one of the twelfth to twentieth aspects, further including a spray nozzle 90 capable of jetting cooling water in a space on a side farther from the final-stage rotor blade row 25z, 55z than the partition plate 80, 80a, 80b in the steam flow path 35, 65.

### INDUSTRIAL APPLICABILITY

According to one aspect of the present disclosure, it is possible to feed steam having a pressure and a temperature corresponding to a request from a steam utilization side to a steam utilization facility.

### REFERENCE SIGNS LIST

10: Steam turbine (before modification)
10a, 10b, 10c: Steam turbine (after modification)
11: Steam turbine rotor
15: Steam turbine casing
16: First bearing
17: Second bearing
20: High-pressure steam turbine unit
21: High-pressure rotor
22: High-pressure rotor shaft
23: Rotor blade row mounting portion
25: Rotor blade row
25z: Final-stage rotor blade row
26: Rotor blade
27: Blade body
28: Blade root
30: High-pressure rotor casing
32: Stator vane row mounting portion
33: High-pressure steam exhaust port
35: High-pressure steam flow path
35u: Upstream space
35d: Downstream space
36: Stator vane row
37: Vane body
38: Outer ring
39: Inner ring
40: High-pressure steam pipe
41: High-pressure steam valve
42: High-pressure shaft sealing device
42s: Seal
42b: Seal support base
43: Intermediate shaft sealing device
43s: Seal
43b: Seal support base
50: Low-pressure steam turbine unit
51: Low-pressure rotor
52: Low-pressure rotor shaft
53: Rotor blade row mounting portion
55: Rotor blade row
55z: Final-stage rotor blade row
56: Rotor blade
57: Blade body
58: Blade root
60: Low-pressure rotor casing
61: Casing main body
62: Stator vane row mounting portion
63: Extracted air port
63x: Port
64: Diffuser
640: Outer diffuser
64i: Inner diffuser
65: Low-pressure steam flow path
65u: Upstream space
65d: Downstream space
66: Stator vane row
67: Vane body
68: Outer ring
69: Inner ring
70: Low-pressure steam pipe
70p: Downstream steam flow path
71: Low-pressure steam valve (partition member)
72: Low-pressure shaft sealing device
72s: Seal
72b: Seal support base
75: Exhaust casing
76: Exhaust space
77: Exhaust port
80, 80a, 80b: Partition plate (partition member)
81, 81a, 81b: Partition plate main body
82, 82a, 82b: Outer end portion
83, 83a, 83b: Inner end portion
84, 84a, 84b: Partition plate seal
85, 85b, 85c: Exhaust pipe (exhaust flow path forming portion)
86, 86b: Closing plate
87: Drain discharge pipe
88: Blind flange
89: Drain discharge pipe
90: Spray nozzle
91: Cooling water line
92: Adjustment valve
93: Thermometer
95a: First steam utilization facility
96a: First steam supply line
95b: Second steam utilization facility
95c: Third steam utilization facility
96c: Third steam supply line
95d: Fourth steam utilization facility
99: Condenser
Ar: Axis
Da: Axial direction
Dau: Axially upstream side
Dad: Axially downstream side
Dc: Circumferential direction
Dr: Radial direction
Dri: Radially inner side
Dro: Radially outer side

1. A method for modifying a steam turbine, the steam turbine comprising:
a rotor rotatable about an axis;
a rotor casing covering an outer peripheral side of the rotor; and
a plurality of stator vane rows provided on an inner peripheral side of the rotor casing and arranged in an axial direction in which the axis extends,
the rotor including a rotor shaft extending in the axial direction about the axis, and a plurality of rotor blade rows provided on the rotor shaft, and
each of the plurality of rotor blade rows being disposed on an axially downstream side, in the axial direction, of any one of the plurality of stator vane rows, the method comprising:
a blade removal step of removing a plurality of rotor blade rows including a rotor blade row on a most axially downstream side and adjacent to each other in the axial direction, or the rotor blade row on the most axially downstream side, among the plurality of rotor blade rows, and removing a stator vane row adjacent to each of the one or more rotor blade rows to be removed on an axially upstream side, in the axial direction, of the one or more rotor blade rows, among the plurality of stator vane rows, and thus at least a rotor blade row on a most axially upstream side, among the plurality of rotor blade rows, remains and at least a stator vane row on the most axially upstream side, among the plurality of stator vane rows, remains; and
a flow path partitioning step of partitioning a steam flow path having an annular shape and formed between the inner peripheral side of the rotor casing and an outer peripheral side of the rotor shaft or a downstream steam flow path communicating with the steam flow path, at a position on the axially downstream side of a final-stage rotor blade row being the rotor blade row on the most axially downstream side, among the one or more rotor blade rows remaining after the blade removal step.

2. The method for modifying a steam turbine, according to claim 1, further comprising:
an exhaust flow path setting step of setting an exhaust flow path configured to lead steam in a space on a side of the final-stage rotor blade row with respect to a position where the steam flow path or the downstream steam flow path is partitioned in the steam flow path to outside of the rotor casing, wherein
in the exhaust flow path setting step, a pipe in which the exhaust flow path is formed is provided.

3. The method for modifying a steam turbine, according to claim 1, wherein
the rotor casing is provided in advance with an extracted air port configured to lead steam in a space on a side of the final-stage rotor blade row with respect to a position where the steam flow path or the downstream steam flow path is partitioned to outside of the rotor casing,
the method further comprises an exhaust flow path setting step of setting, in the steam flow path or the downstream steam flow path, an exhaust flow path configured to lead steam in the space on the side of the final-stage rotor blade row with respect to the position where the steam flow path or the downstream steam flow path is partitioned to outside of the rotor casing, and
in the exhaust flow path setting step, the extracted air port is set as at least a part of the exhaust flow path.

4. The method for modifying a steam turbine, according to claim 1, wherein
the steam turbine includes a steam valve configured to partition the downstream steam flow path, and
in the flow path partitioning step, the downstream steam flow path is partitioned by closing the steam valve.

5. The method for modifying a steam turbine, according to claim 1, wherein
in the flow path partitioning step, the steam flow path is partitioned using a partition plate,
the partition plate includes an inner end portion that is an end portion on a radially inner side in a radial direction with respect to the axis, and an outer end portion that is an end portion on a radially outer side in the radial direction, and
in the flow path partitioning step, the outer end portion of the partition plate is connected to the rotor casing.

6. The method for modifying a steam turbine, according to claim 5, wherein
in the flow path partitioning step, the outer end portion of the partition plate is connected to a stator vane row mounting portion to which the stator vane row on the most axially upstream side, among the one or more stator vane rows removed in the blade removal step, is mounted, in the rotor casing.

7. The method for modifying a steam turbine, according to claim 5, wherein
the steam turbine includes a stationary component disposed at a position on the axially downstream side of the final-stage rotor blade row and including a portion along an outside surface of the rotor shaft, and
in the flow path partitioning step, the inner end portion of the partition plate is brought into contact with the stationary component.

8. The method for modifying a steam turbine, according to claim 7, wherein
in the flow path partitioning step, the inner end portion of the partition plate is brought into contact with the stationary component such that the inner end portion of the partition plate is movable in a direction including a component in a direction in which the partition plate extends.

9. The method for modifying a steam turbine, according to claim 7, wherein
the stationary component is a shaft sealing device that faces the outside surface of the rotor shaft and is configured to suppress outflow of steam to the axially downstream side of the shaft sealing device.

10. The method for modifying a steam turbine, according to claim 1, wherein
the steam turbine includes an exhaust casing configured to lead steam having flowed through the steam flow path to a condenser, and
the method further comprises an exhaust port closing step of closing an exhaust port through which steam is discharged to the condenser in the exhaust casing.

11. The method for modifying a steam turbine, according to claim 1, further comprising:
a spray nozzle installation step of providing a spray nozzle configured to jet cooling water in a space on a side farther from the final-stage rotor blade row than a position where the steam flow path or the downstream steam flow path is partitioned in the steam flow path or the downstream steam flow path.

12. A steam turbine comprising:
a rotor rotatable about an axis;
a rotor casing covering an outer peripheral side of the rotor;
one stator vane row provided on an inner peripheral side of the rotor casing or a plurality of stator vane rows provided on the inner peripheral side of the rotor casing and arranged in an axial direction in which the axis extends;
a partition member that partitions a steam flow path or a downstream steam flow path communicating with the steam flow path; and
an exhaust flow path forming portion in which an exhaust flow path configured to lead steam to outside of the rotor casing is formed, wherein
the rotor includes a rotor shaft extending in the axial direction about the axis, and one or more rotor blade rows provided on the rotor shaft,
each of the one or more rotor blade rows is disposed on an axially downstream side, in the axial direction, of any one of the one or more stator vane rows,
the steam flow path is an annular flow path formed between the inner peripheral side of the rotor casing and an outer peripheral side of the rotor shaft,
the partition member partitions the steam flow path or the downstream steam flow path at a position on the axially downstream side of a final-stage rotor blade row being a rotor blade row on a most axially downstream side, among the one or more rotor blade rows, and
the exhaust flow path is configured to lead steam in a space on a side of the final-stage rotor blade row with respect to a position where the steam flow path or the downstream steam flow path is partitioned in the steam flow path or the downstream steam flow path to outside of the rotor casing.

13. The steam turbine according to claim 12, wherein
the rotor casing includes a stator vane row mounting portion to which a stator vane row is mountable but no stator vane row is mounted, the stator vane row mounting portion being located on the axially downstream side of the final-stage rotor blade row, and
the rotor shaft includes a rotor blade row mounting portion to which a rotor blade row is mountable but no rotor blade row is mounted, the rotor blade row mounting portion being located on the axially downstream side of the final-stage rotor blade row.

14. The steam turbine according to claim 12, further comprising:
a steam valve configured to partition the downstream steam flow path as the partition member, wherein
the steam valve is closed when the downstream steam flow path is partitioned.

15. The steam turbine according to claim 12, further comprising:
a partition plate that partitions the steam flow path as the partition member, wherein
the partition plate includes an inner end portion that is an end portion on a radially inner side in a radial direction with respect to the axis, and an outer end portion that is an end portion on a radially outer side in the radial direction, and
the outer end portion of the partition plate is connected to the rotor casing.

16. The steam turbine according to claim 13, further comprising:
a partition plate that partitions the steam flow path as the partition member, wherein
the partition plate includes an inner end portion that is an end portion on a radially inner side in a radial direction with respect to the axis, and an outer end portion that is an end portion on a radially outer side in the radial direction, and
the outer end portion of the partition plate is connected to the stator vane row mounting portion of the rotor casing.

17. The steam turbine according to claim 15, further comprising:
a stationary component disposed at a position on the axially downstream side of the final-stage rotor blade row and including a portion along an outside surface of the rotor shaft, wherein
the inner end portion of the partition plate is in contact with the stationary component.

18. The steam turbine according to claim 17, wherein
the inner end portion of the partition plate is in contact with the stationary component such that the inner end portion of the partition plate is movable in a direction including a component in a direction in which the partition plate extends.

19. The steam turbine according to claim 17, wherein
the stationary component is a shaft sealing device that faces the outside surface of the rotor shaft and is configured to suppress outflow of steam to the axially downstream side of the shaft sealing device.

20. The steam turbine according to claim 12, further comprising:
an exhaust casing configured to discharge steam having flowed through the steam flow path to a condenser; and
a closing plate that closes an exhaust port configured to discharge steam to the condenser in the exhaust casing.

21. The steam turbine according to claim 12, further comprising:
a spray nozzle configured to jet cooling water in a space on a side farther from the final-stage rotor blade row than the partition member in the steam flow path or the downstream steam flow path.
